(19) United States
(12) Patent Application Publication
(10) Pub. No.: US 2021/0405653 A1
(43) Pub. Date: Dec. 30, 2021

(54) Autonomously Guidable Vehicle Train

(71) Applicant: Volkswagen Aktiengesellschaft, Wolfsburg (DE)

(72) Inventors: Peter Levko, Braunschweig (DE); Roberta Ricci, Braunschweig (DE)

(73) Assignee: Volkswagen Aktiengesellschaft, Wolfsburg (DE)

(21) Appl. No.: 17/355,504

(22) Filed: Jun. 23, 2021

(30) Foreign Application Priority Data
Jun. 26, 2020 (DE) 10 2020 207 960.9

(51) Int. Cl. G05D 1/02; B60R 19/20

(52) U.S. Cl. CPC G05D 1/0295; G05D 1/0289; B60R 19/20; G05D 1/0276

(57) ABSTRACT

An autonomously guidable vehicle train contains a self-driving first lead vehicle, and a first following vehicle, as well as a second following vehicle. The vehicle train contains a first coupling unit in order to couple the first following vehicle to the first lead vehicle, as well as a second coupling unit in order to couple the following vehicles to each other. The first following vehicle has a first drive system as well as a first control unit that is configured to control the first drive system so that the first following vehicle follows the first lead vehicle. The second following vehicle has a second drive system and a second control unit that is configured to automatically control the second drive system so that the second following vehicle follows the first following vehicle.

### CROSS-REFERENCE TO RELATED APPLICATIONS

This application claims priority to German Patent Application No. DE 10 2020 207 960.9, filed on Jun. 26, 2020 with the German Patent and Trademark Office. The contents of the aforesaid Patent Application are incorporated herein for all purposes.

### TECHNICAL FIELD

The present invention relates to an autonomously guidable vehicle train, as well as a method for autonomously guiding a vehicle train.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Motor vehicles are known from the prior art that can be operated fully anonymously, i.e., are self-driving. In order for them to be fully operable without human control, or respectively without support from another vehicle, the self-driving motor vehicle must be thoroughly equipped with sensor systems of every kind, high performance computing units as well as software systems. Particularly when several motor vehicles are to be operated autonomously, this represents an enormous level of development and expense. Moreover, a significant part of the installation space is filled with equipment.

### SUMMARY

An object exists to provide an improved approach for autonomously guiding a vehicle train by means of which the overall requirements for equipping the vehicles of the vehicle train may be reduced.

The object is solved by the subject matter of the independent claims. Embodiments of the invention are described in the dependent claims, the following description, and the drawings.

### BRIEF DESCRIPTION OF THE DRAWINGS

FIG. 1 shows a schematic representation of an exemplary embodiment of an autonomously guidable vehicle train;

FIG. 2 shows a schematic representation of another exemplary embodiment of an autonomously guidable vehicle train;

FIG. 3 shows a schematic representation of another exemplary embodiment of an autonomously guidable vehicle train;

FIG. 4A shows a schematic representation of an exemplary embodiment of an autonomously guidable vehicle train; and

FIG. 4B shows a plan view of part of the vehicle train from FIG. 4a.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

The present teachings are based on the concept of providing a self-driving lead vehicle in a vehicle train and at least two following vehicles that may be coupled to each other, and of which one may be coupled to the lead vehicle. The following vehicles then follow the self-driving vehicle.

According to a first exemplary aspect, an autonomously guidable vehicle train is presented. The vehicle train comprises a self-driving first lead vehicle, a first following vehicle and a second following vehicle. The vehicle train comprises a first coupling unit that is configured to couple the first following vehicle and the first lead vehicle to each other. The vehicle train comprises a second coupling unit that is configured to couple the second following vehicle and the first following vehicle to each other. The first following vehicle has a first drive system as well as a first controller (also referred to as ‘control unit’ or as a processor herein), wherein the first controller is configured to automatically control the first drive system so that the first following vehicle follows the first lead vehicle when the first following vehicle and the first lead vehicle are coupled to each other. The second following vehicle has a second drive system and a second controller (also referred to as ‘control unit’ or as a processor herein), wherein the second controller is configured to automatically control the second drive system so that the second following vehicle follows the first following vehicle, and therefore indirectly the first lead vehicle, when the second following vehicle and the first following vehicle are coupled to each other.

In this context and in the following, a “vehicle train” may be understood to be a combination of at least three vehicles that are guided along a common path or trajectory. According to the present exemplary aspect, the at least three vehicles contain the first lead vehicle as well as the first and the second following vehicle.

In this context and in the following, a “self-driving vehicle”, for example the “self-driving first lead vehicle”, may be understood to be a motor vehicle that is configured to be guided fully autonomously or fully automatically, and for example unmanned, as well as without remote control by a human person and without following a reference vehicle. A self-driving vehicle may accordingly also be termed a robot vehicle. The self-driving vehicle executes all necessary functions such as, if applicable, necessary steering, braking and/or acceleration maneuvers, monitoring and recording of traffic, as well as the associated necessary reactions, independently and fully automatically. For example, the self-driving vehicle may be designed as a vehicle according to level 5 of the classification according to SAE J3016. Here and in the following, “SAE J3016” refers to the corresponding standard in the version of June 2018.

The following vehicles are for example configured to also be guided without direct control or remote control by a human. The following vehicles may therefore be considered to be at least partially automated or semi-autonomous motor vehicles. The following vehicles are however not designed as self-driving vehicles. In other words, the following vehicles rely upon the guidance of another vehicle. This may be done for example by a self-driving vehicle, or by another following vehicle.

Here and in the following, the “coupling of two vehicles to each other by the particular coupling unit” may be understood to mean that an exchange of force and/or information between the particular vehicles coupled to each other is possible through the particular coupling unit so that one of the vehicles may follow the other vehicle based on the exchanged force and/or the exchanged information. It is immaterial whether the vehicle that is being followed is in turn following another vehicle, or whether the vehicle that is being followed is a self-driving vehicle.

A “drive system” may for examplebe understood to mean a system with a drive motor for the particular vehicle. The drive system may in addition also contain a brake system of the particular vehicle and/or a steering system of the particular vehicle. However, the steering system and/or brake system of the particular vehicle may also be designed separately from the drive system.

It is noted that a following vehicle does not necessarily have a steering system according to the teachings herein; however, this may be the case in various embodiments of the vehicle train.

In order to control the first following vehicle, or respectively the second following vehicle so that it follows the first lead vehicle, or respectively the first following vehicle, the particular control unit may therefore control the corresponding drive system and optionally the corresponding brake and/or steering system of the particular following vehicle such that a longitudinal speed and optionally a steering angle of the particular following vehicle is adapted to the current behavior of the preceding first lead vehicle, or respectively first following vehicle, or in other words, the behavior of the leading first lead vehicle or first following vehicle is followed or imitated.

In other words, the first following vehicle also executes, or approximately executes, vehicle guidance maneuvers that the first lead vehicle is performing, possibly at a delay. This applies analogously to the second following vehicle in order to follow the first following vehicle.

According to the teachings herein, only the first lead vehicle should be designed as a self-driving vehicle to realize an autonomously guidable vehicle train, whereas the following vehicle only should be designed so that it may follow another vehicle. Consequently, significantly less effort is required with respect to the sensor systems, other hardware and software systems and/or safety systems that are to be provided. Costs for the overall vehicle train may therefore be saved. Another benefit is that the specific design of the following vehicles may be flexible and for examplemay differ depending on the use of the following vehicle. Accordingly for example, following vehicles for transporting people, following vehicles for providing services, etc. may be equally used. It is also possible but not necessary for all of the following vehicles of the vehicle train to be designed the same.

Another benefit is that installation space in the following vehicles may be reduced by the aforementioned reduced outlay for sensor systems and hardware of the following vehicles, or respectively the installation space may be available for other components or purposes.

In some embodiments of the autonomously guidable vehicle train, the vehicle train contains a self-driving second lead vehicle.

The statements made with regard to the first lead vehicle may be analogously transferred to the second lead vehicle.

For example, the vehicle train may contain a plurality of vehicles that are sequentially arranged when the vehicle train is being autonomously guided. The plurality of vehicles in this case contains the first and the second lead vehicle as well as the first and the second following vehicle, and may optionally contain one or more additional following vehicles. While anonymously driving the vehicle train, the lead vehicles and the following vehicles are arranged so that the first and the second following vehicle as well as the other following vehicles are located between the first and the second lead vehicle.

In other words, the first lead vehicle is a first vehicle of the vehicle train, and the second lead vehicle is a last vehicle of the vehicle train, or vice versa. For example, the lead vehicles and possibly the following vehicles may be configured so that a reversal of direction is also possible so that the first and the second lead vehicle, depending on the direction of movement of the vehicle train, may both serve as the first vehicle of the vehicle train as well as the last vehicle of the vehicle train without changing the arrangement of the following vehicles and the lead vehicles within the vehicle train.

The statements with respect to the first and the second following vehicle may analogously be transferred to the at least one additional following vehicle. For example, each additional following vehicle of the at least one additional following vehicle has a corresponding drive system as well as a corresponding control unit that may control the particular drive system such that it may follow the preceding following vehicle, or respectively lead vehicle.

In some embodiments, the vehicle train comprises a third coupling unit that is configured to couple the second following vehicle and the second lead vehicle to each other.

In some embodiments, the vehicle train comprises another coupling unit that is configured to couple the at least one other following vehicle, for example another following vehicle following the second following vehicle, to each other.

If the vehicle train has the at least one additional following vehicle, the aforementioned savings with respect to the requirements for sensors, hardware and software, and therefore the corresponding cost savings, are even greater. For example, the particular savings are all the greater the more following vehicles the vehicle train contains.

In some embodiments, the vehicle train comprises the second self-driving lead vehicle as well as the at least one following vehicle and another third coupling unit. The additional third coupling unit is configured to couple a final following vehicle of the at least one additional following vehicle and the second lead vehicle to each other.

In some embodiments, the first lead vehicle, for example the brake system of the first lead vehicle, has a brake actuator and a brake control unit, wherein the brake control unit is configured to actuate the brake actuator, e.g., automatically. The first lead vehicle has a communication interface that is configured to wirelessly transmit an information signal to the second lead vehicle, for example a communication interface of the second lead vehicle, depending on the actuation of the brake actuator by the brake control unit.

In such embodiments, the second lead vehicle may react faster to a braking maneuver by the first lead vehicle and therefore for example may more reliably maintain a safety distance between the second lead vehicle and the final following vehicle, or respectively the second following vehicle if the vehicle train does not have the at least one additional following vehicle.

With respect to the brake system, the second lead vehicle may be designed to correspond to the first lead vehicle in some embodiments.

In some embodiments, the first lead vehicle comprises a safety system that is configured to detect the presence of an accident situation. The safety system comprises an impact protection element as well as a trigger element, wherein the trigger element is configured to activate the impact protection element when the presence of the accident situation has been detected.

The activated impact protection element is for example configured, or respectively is arranged in an activated state, such that a collision between the first following vehicle and the first lead vehicle may be prevented, or respectively dampened. This may reduce the accident's consequences in an accident of the first lead vehicle, or respectively in the event of emergency braking by the first lead vehicle, in that damage to the first following vehicle, and possibly the second and/or the additional following vehicles, may be prevented or limited.

In such embodiments, the first lead vehicle therefore assumes safety functions for the vehicle train. The required demands for safety systems in the following vehicles, and accordingly expenses for the entire vehicle train, may thereby be reduced. Moreover, the installation space of the following vehicles may also be thereby reduced, or respectively provided for other purposes.

With respect to the safety system, the second lead vehicle may for example be designed to correspond to the first lead vehicle.

In some embodiments, the impact protection element is at least partially arranged between the first lead vehicle and the first following vehicle when the impact protection element has been activated.

The same holds true for the correspondingly designed second lead vehicle in corresponding embodiments whose impact protection element, upon being activated, is located at least partially between the second lead element and the final following vehicle, or respectively the second following vehicle.

In some embodiments, the safety system comprises an airbag.

In some embodiments, the impact protection element comprises an inflatable cushion. The trigger unit is configured to introduce gas into the inflatable cushion to activate the impact protection element.

This may yield a particularly space-saving design of the safety system in normal operation of the vehicle train, and a high safety effect may be achieved in the case of an accident.

In some embodiments, the first coupling unit comprises an environmental sensor system that is configured to generate at least one sensor signal that represents an area between the first lead vehicle and the first following vehicle. The first control unit is configured to control the first drive system depending on the at least one sensor signal so that the first following vehicle follows the first lead vehicle.

For example, the environmental sensor system is coupled by wire or wirelessly to the first control unit in order to transmit the at least one sensor signal to the first control unit. The environmental sensor system may be arranged on the first lead vehicle, for example on a side of the first lead vehicle facing the first following vehicle, or on the first following vehicle, such as on a side of the first following vehicle facing the first lead vehicle. In different embodiments, one or more components of the environmental sensor system may be arranged on the first lead vehicle, and one or more additional components of the environmental sensor system may be arranged on the first following vehicle.

The environmental sensor system may for example have one or more cameras, one or more radar systems, one or more lidar systems, one or more other active optical sensor systems, one or more ultrasonic sensor systems, and/or one or more other distance sensor systems.

Depending on the at least one sensor signal, the first control unit may for example control the first drive system and optionally the brake system and/or steering system of the first following vehicle such that the distance between the first lead vehicle and the first following the vehicle lies within a given range so that the first following vehicle therefore follows the first lead vehicle.

By using the environmental sensor system of the first coupling unit, it is for example possible to dispense with mechanical or physical connections between the first following vehicle and the first lead vehicle, or respectively to design them simpler. Moreover, without a mechanical or physical connecting element, it is unnecessary to perform manual steps to couple the first lead vehicle and the first following vehicle, for example by a human user.

The above and following statements with respect to the first coupling unit may analogously be transferred to all other coupling units of the vehicle train, for example to the second and third coupling unit, as well as the additional coupling unit. The first lead vehicle and the first following vehicle then need to be replaced by the vehicles that are correspondingly adjacent, or respectively coupled to each other. It is noted that different coupling units of the vehicle train may be designed the same or different from each other.

In some embodiments, the first control unit is configured to regulate a distance between the first lead vehicle and the first following vehicle so that the distance lies within a given range of distance, and/or so that the distance is greater than or equal to a given minimum distance.

The distance may for example be regulated by controlling or regulating the first drive system, and optionally the brake system, and/or the steering system of the first following vehicle. This may further increase safety.

In some embodiments, the first coupling unit comprises a mechanical connecting element that is configured to connect the first lead vehicle to the first following vehicle in order to couple the first lead vehicle and the first following vehicle to each other.

The mechanical connecting element may be provided in addition or alternatively to the environmental sensor system of the first coupling unit in some embodiments.

By means of the mechanical connecting element, the demands on the environmental sensor system and the evaluation of the at least one sensor signal from the environmental sensor system may be reduced, or possibly the demands for the environmental sensor system may be entirely omitted, which in turn leads to savings in installation space and costs for the vehicle train.

In some embodiments, the first coupling unit contains a force sensor that is configured and arranged to generate a force sensor signal depending on a force transmitted by the mechanical connecting element between the first lead vehicle and the first following vehicle. The first control unit is configured to control the first drive system depending on the force sensor signal for example so that the first following vehicle follows the first lead vehicle.

This may prevent excessive mechanical stress on or mechanical damage to the connecting element. Moreover, the following vehicle may therefore react faster to delays or braking maneuvers by the first lead vehicle.

In some embodiments, the first lead vehicle and the second lead vehicle are designed as a single-axis self-balancing vehicle.

This reduces the installation space and/or weight of the first and/or second lead vehicle.

According to a second exemplary aspect, a method for autonomously driving a vehicle train is also presented. The vehicle train comprises a first self-driving lead vehicle, a first following vehicle and a second following vehicle. According to the method, the first following vehicle and the first lead vehicle are coupled to each other, for example by means of a first coupling unit. The second following vehicle and the first following vehicle are coupled to each other, for example by means of a second coupling unit. The first following vehicle is automatically controlled so that the first following vehicle follows the first lead vehicle when the first following vehicle and the first lead vehicle are coupled to each other. The second following vehicle is automatically controlled so that the second following vehicle follows the first following vehicle when the second following vehicle and the first following vehicle are coupled to each other. According to some embodiments, the first lead vehicle is autonomously guided, i.e., for example fully automatically, from a starting position to a given target position.

The first following vehicle and the second following vehicle then correspondingly follow the first lead vehicle from particular positions corresponding to the starting position to the particular position corresponding to the target position.

Other embodiments of the method according to the teachings herein follow from the different embodiments of the vehicle train according to the first exemplary aspect, and vice versa. For Example, a vehicle train in some embodiments may be configured or programmed to execute the method or its embodiments as discussed herein.

The present teachings also encompass combinations of the features of the described embodiments.

In the exemplary embodiments discussed herein, the described components of the embodiments each represent individual features that are to be considered independent of one another, in the combination as shown or described, and in combinations other than shown or described. In addition, the described embodiments can also be supplemented by features of the invention other than those described.

In the following, further exemplary embodiments of the invention are described. Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

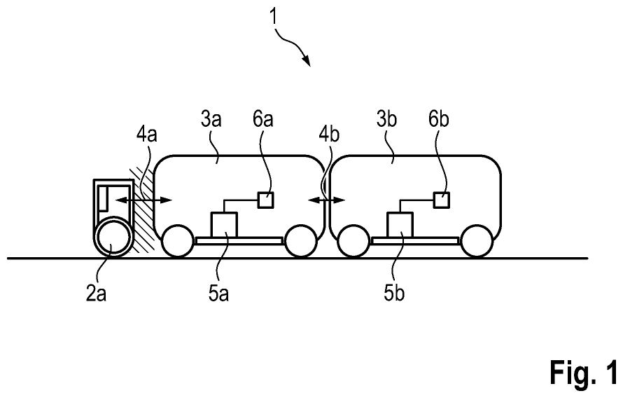

FIG. 1 schematically shows an exemplary embodiment of an autonomously guidable vehicle train 1 according to the improved approach. The vehicle train 1 has a self-driving first lead vehicle 2a, a first following vehicle 3a coupled thereto, as well as a second following vehicle 3b coupled to the first following vehicle 3a. The vehicle train 1 contains a first coupling unit 4a for coupling the first lead vehicle 2a to the first following vehicle 3b, and a second coupling unit 4b for coupling the first following vehicle 3a to the second following vehicle 3b. The first and the second following vehicle 3a, 3b contain a first drive system 5a, or respectively a second drive system 5b, as well as a first control unit 6a and a second control unit 6b.

The coupling units 4a, 4b may be designed as virtual coupling units, or as physical coupling units, or as a combination of the two options. A virtual coupling unit contains an environmental sensor system such as for example one or more cameras, ultrasonic sensors, radar systems or laser distance sensors. A physical coupling unit contains one or more mechanical connecting elements for mechanically connecting the lead vehicle 2a to the first following vehicle 3a. The same holds true with respect to the second coupling unit 4b.

During the operation of the autonomously guidable vehicle train 1, the first lead vehicle 2a is for example guided fully autonomously by an electronic vehicle guidance system (not shown) of the first lead vehicle 2a from a starting position to a given target position. The first control unit 6a is configured to control the first drive system 5a such that the first following vehicle 3a follows the first lead vehicle 2a during its autonomous trip. Correspondingly, the second control unit 6b is configured to control the second drive system 5b so that the second following vehicle 3b follows the first following vehicle 3a and therefore indirectly the first lead vehicle 2a as well.

The first lead vehicle 2a may be designed in various embodiments as a single-axle, self-balancing vehicle.

For example, the first lead vehicle 2a and/or the first following vehicle 3a may in particular ensure, by means of the first coupling unit 4a, that a given safety distance is maintained between the first lead vehicle 2a and the first following vehicle 3a.

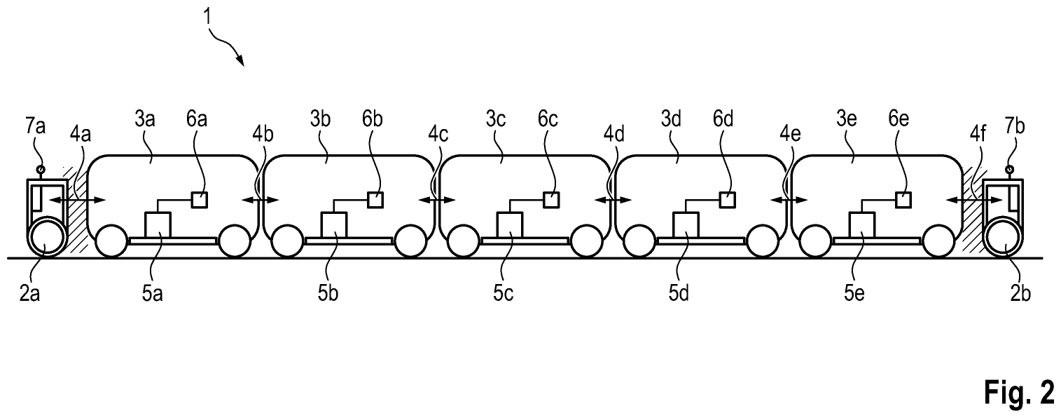

FIG. 2 schematically portrays another exemplary embodiment of a vehicle train 1 according to the improved approach, wherein the vehicle train 1 from FIG. 2 is based on the one from FIG. 1.

The vehicle train 1 from FIG. 2 also has three additional following vehicles 3c, 3d, 3e, wherein the additional following vehicle 3c is coupled by means of a coupling unit 4c to the second following vehicle 3b, the additional following vehicle 3d is coupled by means of a coupling unit 4d to the following vehicle 3c, and the following vehicle 3e is coupled by means of a coupling unit 4e to the following vehicle 3d.

Moreover, the vehicle train 1 has a second self-driving lead vehicle 2b that may be designed analogously to the first self-driving lead vehicle 2a. In doing so, the following vehicles 3a, 3b, 3c, 3d, 3e may be arranged between the first lead vehicle 2a and the second lead vehicle 2b while the vehicle train 1 is operating. The second lead vehicle 2b is coupled by means of a coupling unit 4f to the following vehicle 3e. As described with reference to the following vehicles 3a, 3b, the additional following vehicles 3c, 3d, 3e also have corresponding drive systems 5c, 5d, 5e and control units 4c, 4d, 4e that control them. It is noted that the number of following vehicles in FIG. 2 is only chosen as an example and may also assume different values.

The additional lead vehicle 2b may for example be configured, for example by means of the coupling unit 4f, to maintain a safe distance between the following vehicle 3e and the second lead vehicle 2b.

Optionally, the lead vehicles 2a, 2b may each have a communication interface 7a, 7b. The lead vehicles 2a, 2b may communicate with each other wirelessly via the communication interface 7a, 7b. If a first lead vehicle 2a initiates for example a braking action, a corresponding information signal may be transmitted by means of the communication interface 7a of the first lead vehicle 2a to the communication interface 7b of the second lead vehicle 2b. The second lead vehicle 2b may then react correspondingly to the braking action of the first vehicle 2a and in particular maintain the safe distance.

The additional coupling units 4c, 4d, 4e, 4f may in particular be designed as explained with reference to the coupling units 4a, 4b.

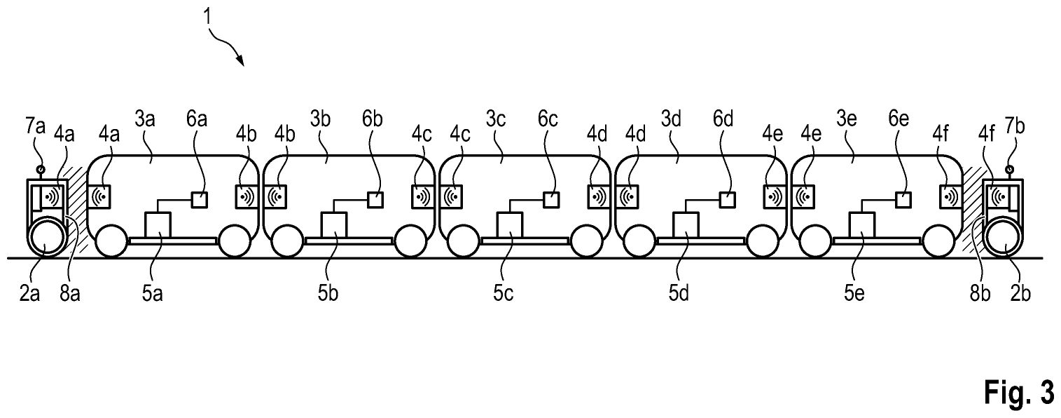

FIG. 3 portrays another exemplary embodiment of a vehicle train according to the improved approach, wherein the vehicle train 1 from FIG. 3 is based on the vehicle train 1 from FIG. 2.

The lead vehicles 2a, 2b of the vehicle train 1 from FIG. 3 each have a safety system 8a, 8b. The safety systems 8a, 8b may for example be designed as airbag systems, wherein corresponding inflatable cushions are filled with gas when an acceleration sensor or another triggering unit of the corresponding vehicle 2a detects the presence of an accident, or a high probability of the presence of an accident. This may further increase safety.

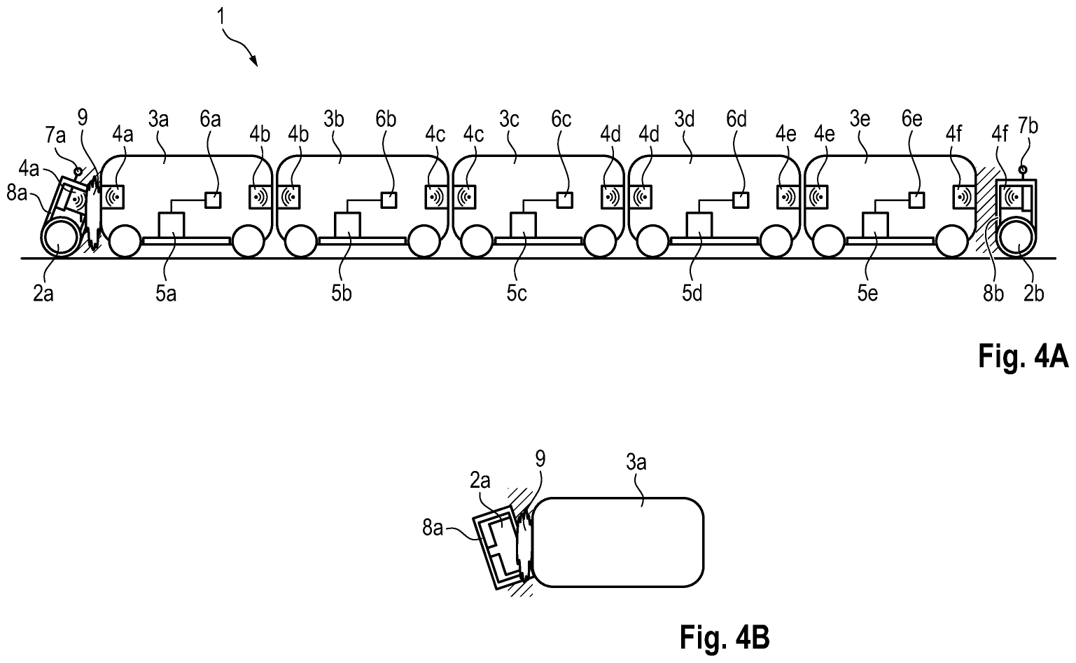

FIG. 4A schematically shows the vehicle train 1 from FIG. 3 in a situation in which the first lead vehicle 2a is involved in an accident or has initiated emergency braking. Furthermore, the inflatable cushion 9 of the safety system 8a is shown in an activated state, i.e., in a state filled with gas. The inflatable cushion 9 filled with gas is then located between the first lead vehicle 2a and the first following vehicle 3a to prevent damage to the first lead vehicle 2a and/or the first following vehicle 3a from the first following vehicle 3a colliding with the first lead vehicle 2a.

FIG. 4A shows the first lead vehicle 2a and the first following vehicle 3a of the vehicle train 1 from FIG. 3, or respectively from FIG. 4a in a plan view.

As stated in particular with respect to the FIGS., the improved approach therefore offers a possibility of realizing an autonomously guidable vehicle train with fewer requirements on sensor systems and hardware and software units to be provided.

By means of the improved approach, increased flexibility with respect to the dimensions and functions of in particular the following vehicles is achieved. The number of following vehicles may in principle be increased as needed to achieve further energy savings.

According to the improved approach, it is unnecessary to provide equipment for autonomous driving, in particular for fully autonomous driving, for each following vehicle, or respectively to provide its own lead vehicle. By outsourcing the fully autonomous driving function to the lead vehicle(s), the entire volume or the entire installation space of the following vehicle(s) is available for its intended use.

In the corresponding embodiments, the lead vehicle, or respectively lead vehicles, take(s) over safety functions, including for the following vehicles. Consequently, less stringent requirements for crumple zones of the following vehicles are to be maintained if applicable, which enables a simpler design of the following vehicles.

### LIST OF REFERENCE NUMERALS

1 Vehicle train
2a, 2b Lead vehicles
3a, 3b, 3c, 3d, 3e Following vehicles
4a, 4b, 4c, 4d, 4e, 4f Coupling units
5a, 5b, 5c, 5d, 5e Drive systems
6a, 6b, 6c, 6d, 6e Control units
7a, 7b Communication interfaces
8a, 8b Safety systems
9 Inflatable cushion

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfill the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. An autonomously guidable vehicle train, wherein:
the vehicle train comprises a self-driving first lead vehicle, a first following vehicle, and a second following vehicle;
the vehicle train comprises a first coupling unit that is configured to couple the first following vehicle and the first lead vehicle to each other;
the vehicle train comprises a second coupling unit that is configured to couple the second following vehicle and the first following vehicle to each other;
the first following vehicle has a first drive system and a first controller that is configured to automatically control the first drive system so that the first following vehicle follows the first lead vehicle when the first following vehicle and the first lead vehicle are coupled to each other; and
the second following vehicle has a second drive system and a second controller that is configured to automatically control the second drive system so that the second following vehicle follows the first following vehicle when the second following vehicle and the first following vehicle are coupled to each other.

2. The autonomously guidable vehicle train of claim 1, wherein
the vehicle train comprises a self-driving second lead vehicle; and
the vehicle train comprises a third coupling unit that is configured to couple the second following vehicle and the second lead vehicle to each other.

3. The autonomously guidable vehicle train of claim 1, wherein
the vehicle train comprises at least one additional following vehicle;
the vehicle train comprises an additional coupling unit that is configured to couple the at least one additional following vehicle and the second following vehicle to each other.

4. The autonomously guidable vehicle train of claim 3, wherein
the vehicle train comprises a self-driving second lead vehicle; and
the vehicle train comprises a third coupling unit that is configured to couple a final following vehicle of the at least one additional following vehicle and the second lead vehicle to each other.

5. The autonomously guidable vehicle train of claim 4, wherein
the first lead vehicle comprises a brake actuator and a brake controller that is configured to actuate the brake actuator; and
the first lead vehicle comprises a communication interface that is configured to wirelessly transmit an information signal to the second lead vehicle depending on the actuation of the brake actuator.

6. The autonomously guidable vehicle train of claim 1, wherein
the first lead vehicle comprises a safety system that is configured to detect the presence of an accident situation; and wherein
the safety system comprises an impact protection element as well as a trigger element that is configured to activate the impact protection element when the presence of the accident situation has been detected.

7. The autonomously guidable vehicle train of claim 6, wherein the impact protection element is at least partially arranged between the first lead vehicle and the first following vehicle when the impact protection element has been activated.

8. The autonomously guidable vehicle of claim 6, wherein
the impact protection element comprises an inflatable cushion; and
the trigger unit is configured to introduce gas into the inflatable cushion to activate the impact protection element.

9. The autonomously guidable vehicle train of claim 1, wherein
the first coupling unit comprises an environmental sensor system that is configured to generate at least one sensor signal that represents an area between the first lead vehicle and the first following vehicle; and
the first controller is configured to control the first drive system depending on the at least one sensor signal.

10. The autonomously guidable vehicle train of claim 9, wherein the first controller is configured to regulate a distance between the first lead vehicle and the first following vehicle so that the distance is greater than or equal to a given minimum distance.

11. The autonomously guidable vehicle train of claim 1, wherein the first coupling unit comprises a mechanical connecting element that is configured to connect the first lead vehicle to the first following vehicle.

12. The autonomously guidable vehicle train of claim 11, wherein
the first coupling unit comprises a force sensor that is configured and arranged to determine a force sensor signal depending on a force transmitted by the mechanical connecting element between the first lead vehicle and the first following vehicle; and wherein
the first controller is configured to control the first drive system depending on the at least one force sensor signal.

13. The autonomously guidable vehicle train of claim 1, wherein the first lead vehicle is configured as a single-axis self-balancing vehicle.

14. A method for autonomously driving a vehicle train that comprises a self-driving first lead vehicle, a first following vehicle, and a second following vehicle, comprising:
coupling the first following vehicle and the first lead vehicle to each other;
coupling the second following vehicle and the first following vehicle to each other;
automatically controlling the first following vehicle i so that the first following vehicle follows the first lead vehicle when the first following vehicle and the first lead vehicle are coupled to each other; and
automatically controlling the second following vehicle so that the second following vehicle follows the first following vehicle when the second following vehicle and the first following vehicle are coupled to each other.

15. The method of claim 14, wherein the first lead vehicle is autonomously guided from a starting position to a given target position.

16. The autonomously guidable vehicle train of claim 2, wherein
the first lead vehicle comprises a safety system that is configured to detect the presence of an accident situation; and wherein
the safety system comprises an impact protection element as well as a trigger element that is configured to activate the impact protection element when the presence of the accident situation has been detected.

17. The autonomously guidable vehicle train of claim 3, wherein
the first lead vehicle comprises a safety system that is configured to detect the presence of an accident situation; and wherein
the safety system comprises an impact protection element as well as a trigger element that is configured to activate the impact protection element when the presence of the accident situation has been detected.

18. The autonomously guidable vehicle train of claim 4, wherein
the first lead vehicle comprises a safety system that is configured to detect the presence of an accident situation; and wherein
the safety system comprises an impact protection element as well as a trigger element that is configured to activate the impact protection element when the presence of the accident situation has been detected.

19. The autonomously guidable vehicle train of claim 5, wherein
the first lead vehicle comprises a safety system that is configured to detect the presence of an accident situation; and wherein
the safety system comprises an impact protection element as well as a trigger element that is configured to activate the impact protection element when the presence of the accident situation has been detected.

20. The autonomously guidable vehicle of claim 7, wherein
the impact protection element comprises an inflatable cushion; and
the trigger unit is configured to introduce gas into the inflatable cushion to activate the impact protection element.
